(19) United States
(12) Patent Application Publication
(10) Pub. No.: US 2022/0400861 A1
(43) Pub. Date: Dec. 22, 2022

(54) FLOATING SHELF SYSTEM

(71) Applicant: Eye Designs, LLC, Collegeville, PA (US)

(72) Inventors: James B. ELDON, III, Barto, PA (US); Richard WINIG, Bryn Mawr, PA (US); Alan M. WINIG, Bryn Mawr, PA (US)

(21) Appl. No.: 17/353,903

(22) Filed: Jun. 22, 2021

(51) Int. Cl. A47B 96/02; F16B 5/06

(52) U.S. Cl. CPC A47B 96/028; F16B 5/0614; F16B 2005/0678

(57) ABSTRACT

A shelf system includes a panel including a first opening; a plug in the first opening, the plug including a wing that extends from a rear of the plug and is angled with respect to a side of the plug, and a second opening; and a shelf including a tongue, the tongue inside the second opening such that the shelf is retained with respect to the panel by the plug.

### FIELD OF THE DISCLOSURE

The present disclosure relates to the field of shelving, and more particularly to a floating shelf system for displaying and storing a product.

### BACKGROUND

Retail displays are critical to the sales of consumer products as they are the means by which products are positioned in the view and reach of prospective purchasers. Product displays are therefore configured to hold and position as much product as possible in the view of consumers in an orderly and appealing arrangement. To this end, a great variety of product display racks and product support devices have been contrived for all types of products. As the number of different types of displays multiplies, greater amounts of store space is occupied to the extent that not all displays can be on the sales floor at the same time. For seasonal items, display racks are moved about a store throughout the year, according to demand and sales results. In many stores, seasonal display racks are placed in storage during the off-season. In large stores, this can lead to permanent misplacement of some display racks and the inventory carried thereon. In the retail sale of expensive and delicate items it is important that each article be displayed in such a way that it appears attractive and is protected from damage.

There are many styles and systems of retail shelving and racks. These include slatwall, gridwall, and gondola styles. Slatwall systems have horizontal channels, gridwall fixtures have square grid patterns, and gondolas have vertical channels on each side of a panel. Each shelving system has its own specific set of accessories designed to hook into the grids or channels. Shelves are a popular solution for retailers and are able to support most types of merchandise.

Shelving and rack systems can be made modular as wire frame, wood racks with plywood or solid wood construction, snap together plastic panels and shelves, or combinations thereof. Wall mount shelving conventionally includes a holding features such as a bracket or panel and a mating shelf. The shelf can be any geometric shape.

More recently customers want better products and a better shopping experience. Thus, it is important to keep pace with evolving technologies to streamline workflow and enhance the customer experience. Visual merchandising uses sight to entice consumers by using attractive displays and arrangements of products. Visual merchandising attempts to create a certain mood using all aspects of interior design including the spatial environment, lighting, signage, and product presentation. Thus, tools are needed to display products in a manner attractive to consumers.

### SUMMARY

The present disclosure relates to a floating shelf system. The shelf system can include a panel, a plug in a hole in the panel, and a shelf inserted into the plug.

In an embodiment, a shelf system includes a panel including a first opening; a plug in the first opening, the plug including a wing that extends from a rear of the plug and is angled with respect to a side of the plug, and a second opening; and a shelf including a tongue, the tongue inside the second opening such that the shelf is retained with respect to the panel by the plug.

In an embodiment of the shelf system, an end of the wing is outside a dimension of the first opening. In an embodiment of the shelf system, the plug includes two wings, one each on opposite sides of the plug.

In an embodiment of the shelf system, the plug includes a tab on an inside surface of the second opening, the tab protruding from the inside surface of the opening and directly contacting the tongue. In the shelf system, a thickness of the tab is thinner in a direction toward the shelf than in an opposite direction toward an end of the tongue.

In another embodiment, a shelf system, includes a panel including a first opening; a plug in the first opening, the plug including a plurality of ribs that extend from a side of the plug and are angled with respect to a side of the plug, and a second opening; and a shelf including a tongue, the tongue inside the second opening such that the shelf is retained with respect to the panel by the plug. In the shelf system, an end of each of the plurality of wings is angled toward the shelf.

In the shelf system, some of the plurality of ribs extend from one side the plug and some of the plurality of ribs extend from another side of the plug that is opposite to the one side of the plug. In the shelf system, the plug includes a tab on an inside surface of the second opening, the tab protruding from the inside surface of the second opening and directly contacting the tongue. In the shelf system, a thickness of the tab is thinner in a direction toward the shelf than in an opposite direction toward an end of the tongue.

In another embodiment, a plug that holds a shelf includes a body; a flange connected to and extending wider than the body; a first opening through the flange and the body in which to receive a portion of the shelf; a retaining member extending from the body toward the flange and that retains the plug within a second opening in a panel and a rear surface of the flange contacting a surface of the panel. The plug can further include a tab on an inside surface of the first opening, the tab protruding from the inside surface of the first opening and being thicker as the tab extends away from the flange. In the plug, the tab directly contacts the portion of the shelf when the shelf is received within the first opening.

In the plug, the retaining member extends from a rear of the body towards the flange and is angled with respect to a side of the body. In the plug, an end of the retaining member closest to the flange extends away from the side of the body such that it is outside a dimension of the second opening of the panel. In the plug, the retaining member is two V-shaped shafts, one each on opposite sides of the body.

In the plug, the retaining member extends from a side of the body towards the flange and is angled with respect to the side of the body. In the plug, the retaining member includes a plurality of first ribs that extend from a first side the body and a plurality of second ribs that extend from a second side of the body that is opposite to the first side of the body. The plug can be made of acrylonitrile butadiene styrene (ABS).

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIGS. 1 and 2 are two isometric views of a floating shelf system according to an embodiment of the present invention.

FIG. 4 is a front isometric view of a panel and a plug without a shelf.

FIG. 5 is a side view of a panel and a plug.

FIG. 6 is a rear view of a panel and a plug.

FIG. 7 is a top view of a panel and a plug.

FIGS. 8-10 are views of a plug according to an embodiment of the present invention.

FIG. 11 is a side cross-sectional view of the floating shelf system including the shelf, the panel, and the plug.

FIGS. 12-14 are views of a plug according to another embodiment of the present invention.

### DETAILED DESCRIPTION OF PREFERRED EMBODIMENTS

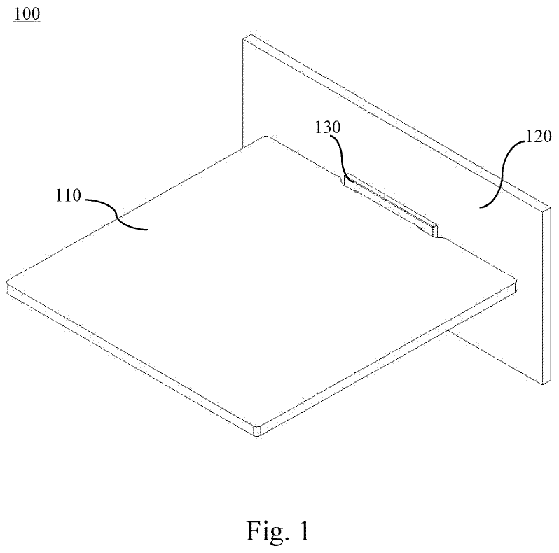

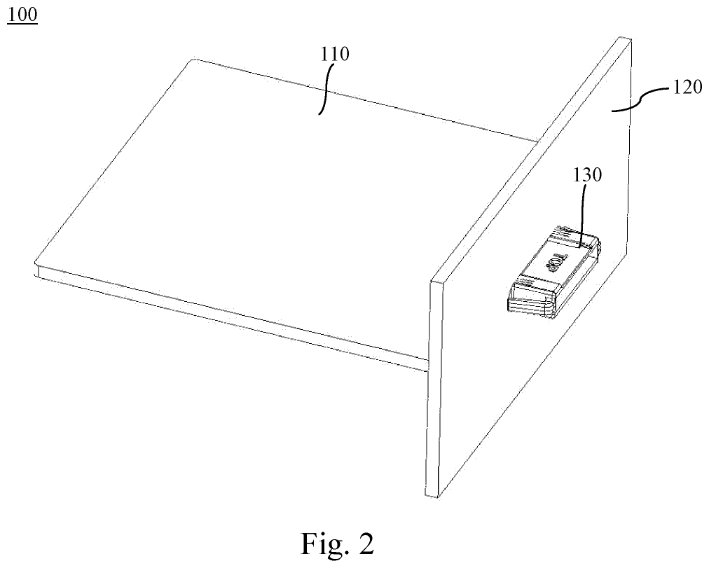

FIGS. 1 and 2 are two isometric views of a floating shelf system 100 according to a preferred embodiment of the present invention. As shown, the shelf system 100 can include a shelf 110, a panel 120, and a plug 130. Because the support mechanism is mostly hidden, the shelf 110 appears to “float” with respect to the panel 120.

The panel 120 can be substantially plate-shaped with two dimensions (i.e., a length and a width) that are substantially longer than a third dimension (i.e., a thickness). As shown, the panel 120 can be rectangular but can also be round, oval, or any suitable geometric shape. The panel 120 can include a hole in which the plug 130 is inserted and retained. Although only one hole and one plug 130 is shown in the panel 120, the panel 120 can include a series or array of holes and corresponding plugs 130. The panel 120 can be wood, plastic, metal, composite, laminate, or any suitable material. The panel 120 can be finished or tinted in any color or can be transparent or translucent. For example, the panel 120 can be plastic with a thickness of 0.216 inches within manufacturing tolerance.

As shown, the shelf 110 can also be substantially plate-shaped with two dimensions (i.e., a length and a width) that are substantially longer than a third dimension (i.e., a thickness). As shown, the shelf 110 can be rectangular but can also be round, oval, or any suitable geometric shape. FIG. 3 shows that the shelf 110 can include a tongue 112 that protrudes from one side of the shelf 110 that can be inserted into the plug 130 to secure the shelf 110 to the panel 130. The shelf 110 can be wood, plastic, metal, composite, laminate, or any suitable material. The shelf 110 can be finished or tinted in any color or can be transparent or translucent. Preferably, the shelf 110 is made from poly(methyl methacrylate) (PMMA). Optionally, the shelf 110 can be made as a wire grid, bracket, wire frame, post, shaft, or as any suitable configuration with a tongue 112 that is configured to mate with the plug 130.

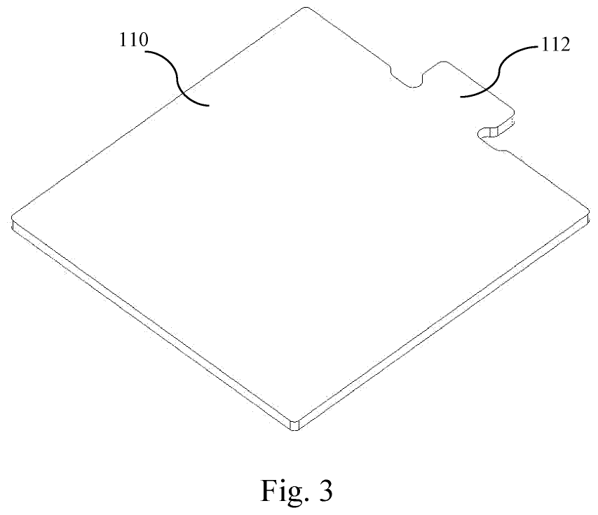

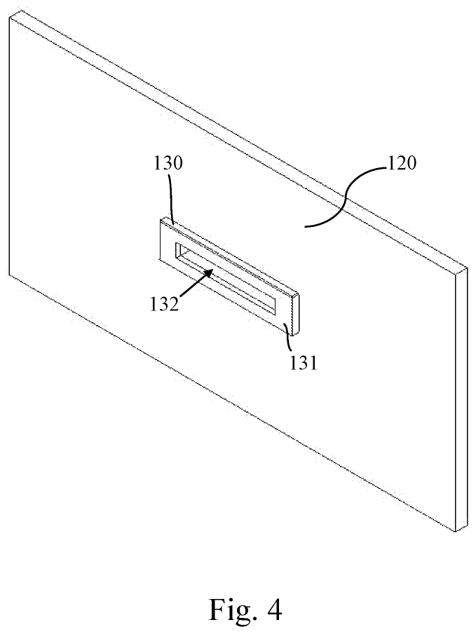

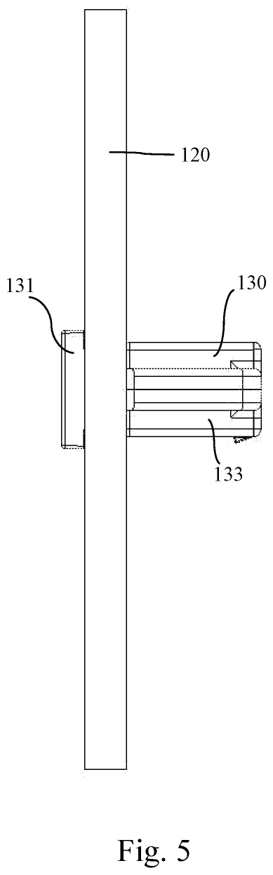

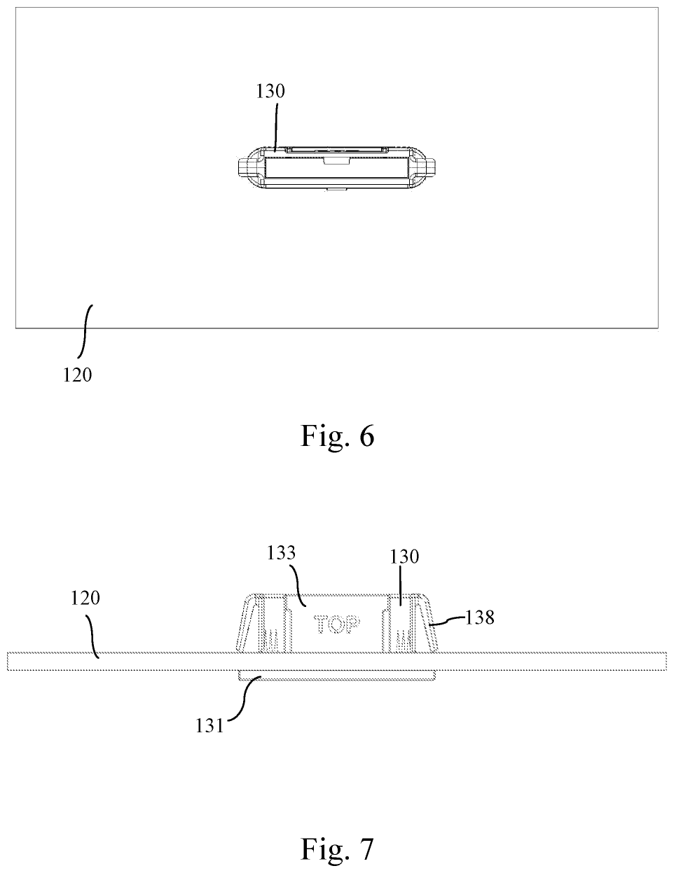

FIG. 4 is a front isometric view of the panel 120 and the plug 130 without a shelf. FIG. 5 is a side view of the panel 120 and the plug 130. FIG. 6 is a rear view of the panel 120 and the plug 130. FIG. 7 is a top view of the panel 120 and the plug 130.

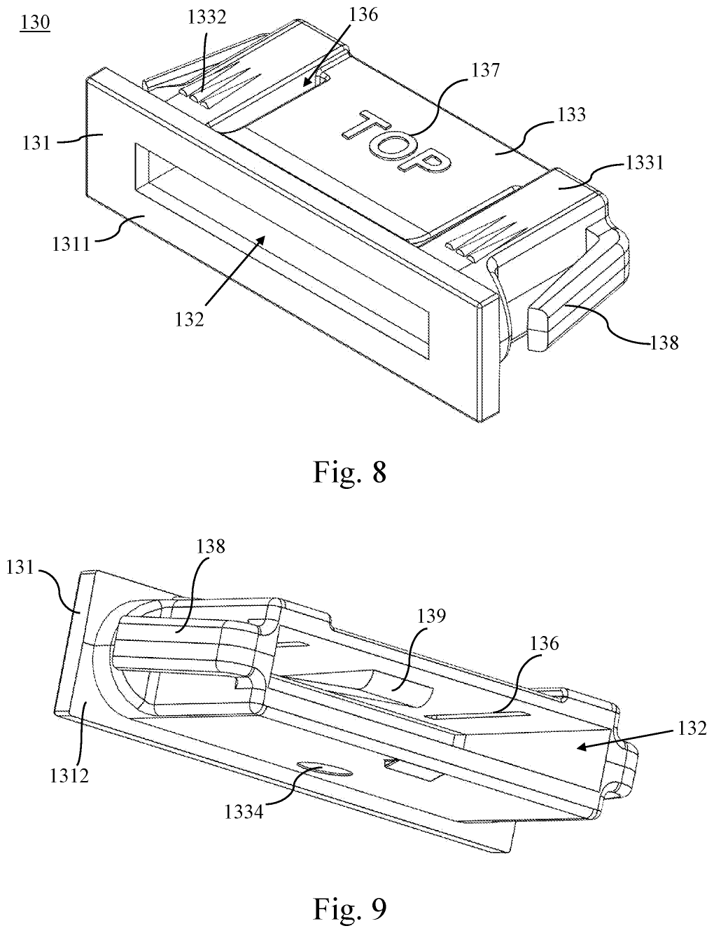

As shown in FIGS. 4, 5, and 7 the plug 130 can include a flange 131 on a shelf side of the panel 120, an opening 132 in the flange 131 that is configured to accept a tongue of a shelf, and a body 133 through an opening in the panel 120 and protruding from a side of the panel 120 opposite to the shelf side. The plug 130 is described in detail below with respect to FIGS. 8-10.

FIG. 8 is a top isometric view of the plug 130. FIG. 8 shows that the flange 131 can be rectangularly shaped. Optionally, the flange 131 can be circularly or elliptically shaped or can be shaped in any suitable fashion. As shown, the flange 131 can include a substantially flat outer surface 1311. Optionally, decorative reliefs or protrusions can be included in the outer surface 1311. As shown, the flange 131 can include the opening 132 that can be rectangularly shaped to receive a tongue of a shelf. The length and width of the flange 131 both extend farther outward than the body 133 so that the body 133 can fit through an opening in a panel but the flange 131 will not. FIG. 9 shows that a back surface 1312 of the flange 131 is substantially flat so that the flange 131 can be arranged to fit flush with a front surface of a panel when installed in the panel.

FIG. 8 also shows that the body 133 can be substantially cubic shaped and include a substantially flat top surface. As shown, the top surface of the body 133 can include two stepped portions 1331, one on each side, symmetric about a center between two sides of the body 133. The stepped portions 1331 can include one or more alignment features 1332. As shown, each stepped portion 1331 includes three alignment features 1332 that are protrude upwardly from the stepped portion 1332 and have a hemispherical cross section that increases in thickness as the alignment features 1332 extend from the rear of the body 133 toward the flange 131. The structure of increasing in thickness from the rear of the body 133 toward the allows for the plug 130 to allows the alignment features 1332 to align the plug 130 in an opening in a panel and make up any dimensional tolerances between the panel opening and the plug 130 to ensure a tight fit in the panel.

FIGS. 8-10 all show that the top surface of the body 133 can include a slot 136. As shown, the top surface of the body 133 can include two slots 136 one each directly adjacent to the stepped portions 1332. The slots 136 relieve stiffness from the body 133 to allow the body 133 to flex during installation into the panel and while receiving a tongue of a shelf to accommodate for manufacturing tolerances between the panel opening, the plug 130, and the shelf.

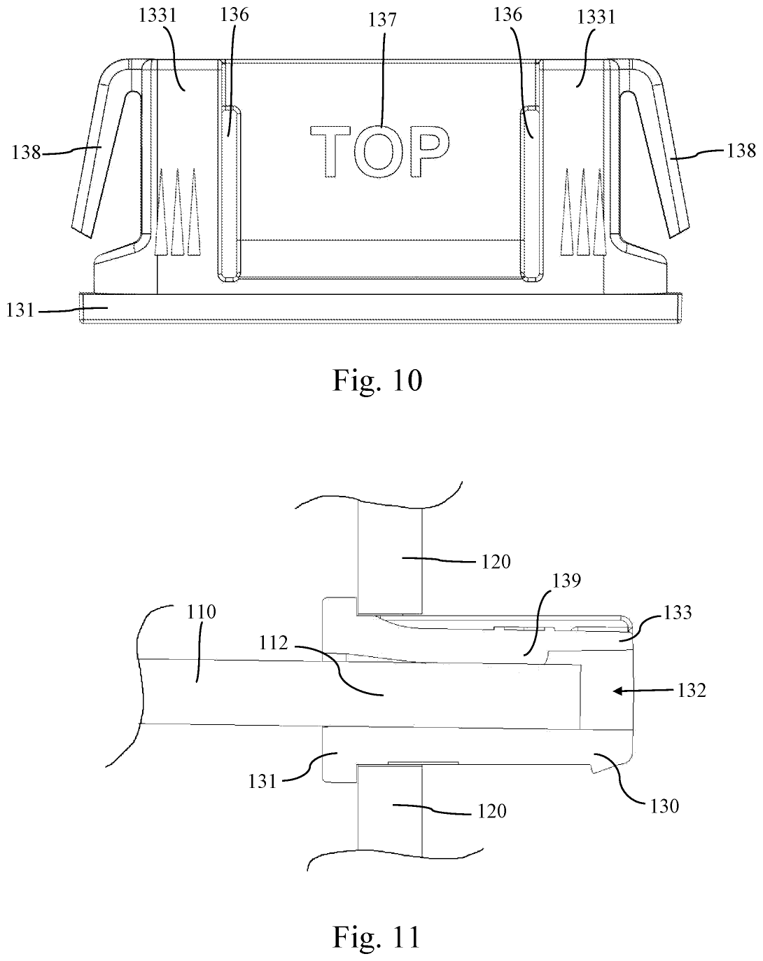

As shown in FIGS. 8 and 10, the plug 130 can include an orientation marking 137 shown as the word “TOP”. The orientation marking 137 indicates the orientation in which the plug 130 should be correctly inserted into a panel. That is, the surface including the orientation marking 137 as “TOP” should be facing upward when inserted into a panel. Optionally, the orientation marking 137 can read “UP” or include any other suitable word or symbol. Optionally, the orientation marking 137 can be included on an opposite surface of the body 133 and read “BOTTOM or “DOWN” or include any other suitable word or symbol.

FIGS. 8-10 all show that the plug 130 can include a wing 138 that extends from a side of the body 133. As shown, the plug 130 can include two wings 138, one each extending from opposite sides of the body 133. The wings 138 can extend to substantially form a V-shape with a corresponding side of the body 133. As shown, each wing 138 extends from and is angled with respect to a rear of the body 133 so that it is farther from a corresponding side of the body as the wing 138 extends closer to the flange 131. The wings 138 are meant to bend or flex with respect to the body 133 so that the wings 138 can be compressed towards the body 133 as the plug 130 is pressed into an opening of a panel. That is, a width of the opening in panel is designed to be less that a dimension between ends of the wings 138. The extending length of the wings 138 is such that once through the opening in the panel, a spring force in the wings 138 returns the wings 138 to its angled V-shape with respect to the body 133 as the end of the wing 138 clears a thickness of the panel. As such, the wings 138 extends outwardly from the body 133 farther than the width of the panel opening panel so that the wings 138 prevents the plug 130 from returning in the direction in which it was inserted into the panel opening. The length of the wings 138 are designed to accommodate a thickness of the panel with manufacturing tolerances.

To remove the plug 130 from a panel, the wings 138 must be physically compressed toward each other and the respective sides of the body 133 to inside and clear the width of the panel opening before the plug 130 can be pushed back out through the panel opening.

FIG. 9 is a bottom-rear isometric view of the plug 130 and shows that a surface of the body 133, shown as the bottom surface, can include a marking location 1334. The marking location 1334 can include information such as a part number, a data code, a batch number, a manufacturer, a lot code, or the like.

FIG. 9 also shows that the plug 130 can include an internal tab 139 structured as a protruding ramp portion on an inside surface of opening 132 and under the top surface of the body 133. As shown, the tab 139 becomes thicker as the tab 139 extends farther away from the flange 131. This arrangement effectively reduces the thickness or interference clearance of the opening 132 in a direction away from the flange 131. Although shown on an inside top surface of the opening 132, the tab 139 can be located on any inside surface of the opening 132. Optionally, there can more than one tab 139 on any one of or on multiple inside surfaces of the opening.

The plug 130 can be cast, molded, injection molded, machined, or made with any suitable manufacturing process or combination thereof as one piece. The plug can be made of metal, alloy, composite, plastic, or any suitable material. Preferably, the plug 130 is injection molded and made of acrylonitrile butadiene styrene (ABS). The plug 130 can be any color as a function of the raw material or ABS resin. Optionally, the plug 130 can be finished with a process such as painting, anodizing, appliqué, powder coat, etc. with any color or pattern. Optionally, only the flange 131 of the plug 130 is finished.

FIG. 11 is a side cross-sectional view of the floating shelf system including the shelf 110, the panel 120, and the plug 130. FIG. 11 shows that the flange 131 of the plug 130 extends larger than the panel opening and fits flush to the panel surface on a side towards the shelf 110 while the body 133 of the plug 130 extends through the panel opening. As shown, the tongue 112 of the shelf 110 has been inserted into the opening 132 of the plug 130 and is pinched and retained in the plug 130 by a compression force from the tab 139.

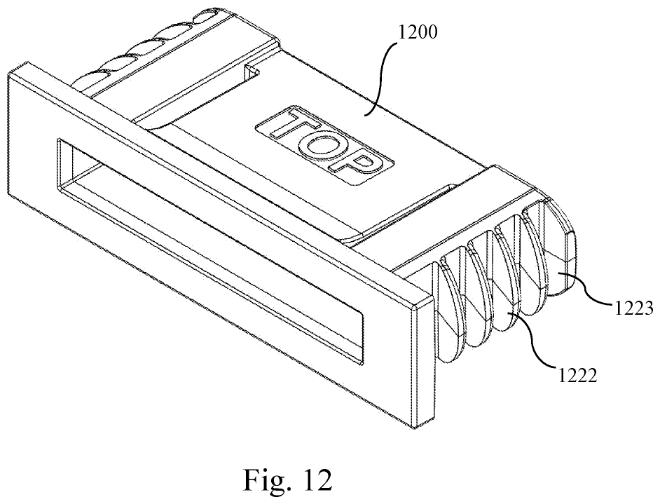

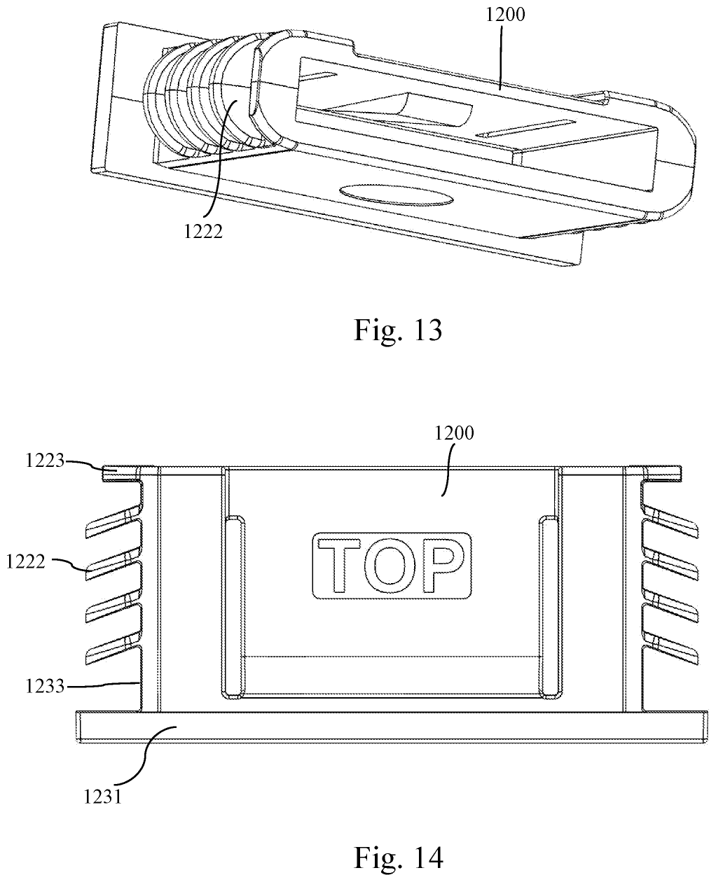

FIGS. 12-14 show a plug 1200 according to another embodiment of the present invention. As shown in FIGS. 12-14 the plug 1200 includes many of the same or similar features to the plug 130 described above. A detailed description of those like features is omitted for brevity.

A substantial different between the plug 1200 and the plug 130 is that the plug 1200 does not include any wings 138. Instead of wings, the plug 1200 includes a series of flexible ribs 1222 and 1223 that extend from each side 1233 of the body of the plug 1200. As shown, in the top view of FIG. 14, the ribs 1222 can extend such that an end of each rib 1222 is father from the corresponding side 1233 of the body than an end of the rib 1223. Also as shown, the ribs 1222 can extend to be angled toward the flange 1231 and the ribs 1223 can extend to be substantially parallel to a rear surface of the flange 1231. As such, the ribs 1222 and 1223 are configured to operate with a panel that is thicker or made differently than the panel 120. More particularly, the plug 1200 is configured to be inserted into an opening in a panel made of wood, plywood, particle board, medium-density fiberboard (MDF), wood laminate, melamine, and the like.

Because the ribs 1222 are angled toward the flange 1231, the ribs 1222 are angled opposite to the insertion direction. While being inserted into the panel opening, the ribs 1222 will flex inwardly toward the corresponding side 1233 of the body of the plug 1200 and in the direction of the flange 1231. By nature, an inside surface of an opening cut into a panel made of such wooden materials is textured or roughened, and once the plug 1200 is inserted into the panel opening, the ends of the ribs 1222 will be angled toward the direction from which the plug 1200 was inserted and dig into the inside surface of the panel opening. This arrangement and holding force prevents disengagement of the plug 1200 from the panel.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. A shelf system, comprising:
a panel including a first opening;
a plug in the first opening, the plug including a wing that extends from a rear of the plug and is angled with respect to a side of the plug, and a second opening; and
a shelf including a tongue, the tongue inside the second opening such that the shelf is retained with respect to the panel by the plug.

2. The shelf system of claim 1, wherein an end of the wing is outside a dimension of the first opening.

3. The shelf system of claim 1, wherein the plug includes two wings, one each on opposite sides of the plug.

4. The shelf system of claim 1, wherein the plug includes a tab on an inside surface of the second opening, the tab protruding from the inside surface of the opening and directly contacting the tongue.

5. The shelf system of claim 4, wherein a thickness of the tab is thinner in a direction toward the shelf than in an opposite direction toward an end of the tongue.

6. A shelf system, comprising:
a panel including a first opening;
a plug in the first opening, the plug including a plurality of ribs that extend from a side of the plug and are angled with respect to a side of the plug, and a second opening; and
a shelf including a tongue, the tongue inside the second opening such that the shelf is retained with respect to the panel by the plug.

7. The shelf system of claim 6, wherein an end of each of the plurality of wings is angled toward the shelf.

8. The shelf system of claim 6, wherein some of the plurality of ribs extend from one side the plug and some of the plurality of ribs extend from another side of the plug that is opposite to the one side of the plug.

9. The shelf system of claim 6, wherein the plug includes a tab on an inside surface of the second opening, the tab protruding from the inside surface of the second opening and directly contacting the tongue.

10. The shelf system of claim 9, wherein a thickness of the tab is thinner in a direction toward the shelf than in an opposite direction toward an end of the tongue.

11. A plug that holds a shelf, the plug comprising:
a body;
a flange connected to and extending wider than the body;
a first opening through the flange and the body in which to receive a portion of the shelf;
a retaining member extending from the body toward the flange and that retains the plug within a second opening in a panel and a rear surface of the flange contacting a surface of the panel.

11. The plug of claim 10, further comprising a tab on an inside surface of the first opening, the tab protruding from the inside surface of the first opening and being thicker as the tab extends away from the flange.

12. The plug of claim 11, wherein the tab directly contacts the portion of the shelf when the shelf is received within the first opening.

13. The plug of claim 10, wherein the retaining member extends from a rear of the body towards the flange and is angled with respect to a side of the body.

14. The plug of claim 13, wherein an end of the retaining member closest to the flange extends away from the side of the body such that it is outside a dimension of the second opening of the panel.

15. The plug of claim 13, wherein the retaining member is two V-shaped shafts, one each on opposite sides of the body.

16. The plug of claim 10, wherein the retaining member extends from a side of the body towards the flange and is angled with respect to the side of the body.

17. The plug of claim 10, wherein the retaining member includes a plurality of first ribs that extend from a first side the body and a plurality of second ribs that extend from a second side of the body that is opposite to the first side of the body.

18. The plug of claim 10, wherein the plug is made of acrylonitrile butadiene styrene (ABS).
